(19) United States
(12) Patent Application Publication
(10) Pub. No.: US 2018/0213316 A1
(43) Pub. Date: Jul. 26, 2018

(54) HEADPHONE WITH ANGLED DRIVER AND NOZZLE

(71) Applicant: TELOS ACOUSTICS, LLC, Draper, UT (US)

(72) Inventor: Tetsuro Oishi, Santa Barbara, CA (US)

(21) Appl. No.: 15/542,243

(22) PCT Filed: Jan. 7, 2016
(86) PCT No.: PCT/US2016/012531

§ 371 Date: Dec. 5, 2017

Related U.S. Application Data
(60) Provisional application No. 62/100,847, filed on Jan. 7, 2015.

(51) Int. Cl. H04R 1/10; H04R 1/28

(52) U.S. Cl. CPC H04R 1/1016; H04R 1/1066; H04R 2420/07; H04R 1/2811; H04R 2201/107; H04R 1/1033

(57) ABSTRACT

An earphone is disclosed having a first housing including a first housing mounting plane and a central axis normal to the first housing mounting plane, a second housing mounted to the first housing, a speaker mounted on the first housing, wherein the speaker defines a speaker axis, and a nozzle having a nozzle axis and extending from the first housing. The normal angle between the speaker axis and the first housing mounting plane defines a speaker axis angle and the normal angle between the nozzle axis and the first housing mounting plane defines a nozzle axis angle. In one embodiment, the speaker axis angle is greater than the nozzle axis angle.

### BACKGROUND

### Technical Field

This invention relates to headphones. More specifically, the disclosure relates to in-ear headphones configured for increased comfort and audio playback quality.

### DETAILED DESCRIPTION OF EMBODIMENTS

In the illustrated embodiment, the headphone 10 comprises a front housing 12, a rear housing 14 coupled to the front housing 12, a speaker 16 mounted to the front housing 12, a strain relief 18 coupled to the rear housing 14, and a cable 20 electrically communicating with the speaker 16 and extending from the strain relief 18 to a plug 22 adapted to be received into an audio playback device 24. When coupled together the front and rear housings 12, 14 define the headphone housing 26. The front and rear housings 12, 14 are sized and configured such that when the front and rear housing 12, 14 are coupled together the front and rear housings 12, 14 define a speaker housing 28. Speaker housing 28 is sized and configured to allow the speaker 16 to be mounted on the front housing 12 and the cable 20 to be electrically connected or coupled to the speaker 16 while enabling the cable 20 to extend through the rear housing 14 to and through the strain relief 18.

The front housing 12 is adapted to be at least partially inserted into the ear canal of a user and rest inside a portion of the ear. The front housing 12 can include a first side 30 adapted to be coupled to the rear housing 14, an opposing second side 32, a nozzle 34 extending from the second side 32 away from the first side 30, and a port 36 sized and configured to assist with regulation of the pressure in the speaker housing 28 generated by actuation of the speaker 16. In the illustrated embodiment, the first side 30 is substantially flat and forms a mounting surface 38. The mounting surface 38 can define a front housing mounting plane 40. Normal to the front housing mounting plane 40 is a central axis 42 positioned substantially in the center of the front housing 12.

Front housing 12 includes a speaker mount 44 configured to receive the speaker 16 thereon. Speaker mount 44 is sized and configured to correspond to a portion of the speaker 16 so as to provide a mounting location for the speaker 16. In one example, speaker mount 44 includes an at least partially cylindrical shaped portion sized to correspond to the outer diameter of the speaker 16 and a terminating surface on which a portion of the speaker 16 can be positioned. The cylindrical portion includes a center axis that defines a cylindrical portion axis 46. A center axis 48 of the speaker 16 when mounted in the speaker mount 44 can likewise define the cylindrical portion axis 46. In other words, the cylindrical portion axis 46 and the speaker center axis 48 are aligned when the speaker 16 is mounted on the speaker mount 44. The cylindrical portion and terminating surface of the speaker mount 44 allow sufficient space for the cable 20 to be electrically coupled to the speaker 16 when the speaker 16 is mounted and secured in the speaker mount 44. Positioning of the speaker 16 on the front housing 12 enables more efficient use of space in the speaker housing 28. For example, additional space in the speaker housing 28 can be utilized for additional electronic components.

Speaker 16 can be secured in speaker mount 44 by numerous methods of attachment. For example, speaker 16 can be fixed or secured in speaker mount 44 by an adhesive, such as glue or adhesive tape, or can be secured by an interference fit between speaker 16 and speaker mount 44, or alternatively, speaker mount 44 can include a lip to secure speaker therein by an interference fit or to correspond to a ridge or feature included on the outer surface of the speaker 16. Having the speaker 16 mounted on the front housing 12 is advantageous because it allows for the front housing 12 to remain essentially unchanged in so far as form is concerned when different rear housings are used to form a headphone, thus reducing manufacturing costs and differing part counts across different models of headphones.

Various sizes and shapes of speakers can be utilized without departing from the scope of the invention. For example, in one embodiment, the speaker 16 is a 7 mm driver. In another embodiment, the speaker 16 is an 8 mm driver. In yet another embodiment, the speaker 16 is a 10 mm driver. In yet another embodiment, speaker 16 is a 12 mm driver. Furthermore, it is contemplated that various types of drivers can be utilized without departing from the scope of the invention. For example, in one embodiment, the speaker 16 is a dynamic driver. In another embodiment, the speaker 16 is a balanced armature. In yet another embodiment, the speaker 16 is a flat, planar or ortho-dynamic driver.

The rear housing 14 includes rear housing mounting surface 50 that is sized and configured to interact and couple with the front housing mounting surface 38, thereby when coupled the front and rear housings 12, 14 define the speaker housing 28. The rear housing mounting surface 50 defines a rear housing mounting plane 52. When the front housing 12 is coupled to the rear housing 14, the front housing mounting plane 40 and the rear housing mounting plane 52 are coplanar.

In one embodiment the front housing mounting surface 38 can include a male portion 54 and the rear housing mounting surface can include female portion 56 adapted to receive the male portion 54 of the front housing 12 therein. To couple the housings 12, 14 together, the male portion 54 of the front housing 12 can be inserted into the female portion 56 of the rear housing 14. The male and female portions 54, 56 can be configured to correspond with each other thereby forming a snap fit when joined together.

The male and female portions 54, 56 can be secured to each other by one or more of the following methods: interference fit, a lip and ridge securement, an adhesive such as glue or tape, or a threaded arrangement. It is understood that the front housing mounting surface 38 can include the female portion and the rear housing mounting surface 50 can include the male portion. Furthermore, it is contemplated that the front housing surface can include both male and female portions that correspond to male and female portions of the rear housing surface so as to interlock the surfaces together wherein the male portions of one surface correspond to female portions of the other surface.

In the illustrated embodiment, the rear housing 14 includes a rear housing base 58, a first side 60 having the rear housing mounting surface 50 and a second side 62. The second side 62 of the rear housing 14 can include one or more decorative caps 64, 66 secured to the rear housing 14. One or more decorative caps 64, 66 can be snap fitted to the rear housing base 58 in a permanent manner or a temporary manner. For example, it is contemplated that a decorative cap 64, 66 can be temporarily fixed to the rear housing base 58 so as to provide replacement of the decorative cap 64, 66 according to the desires of the user.

Various decorative caps can be then utilized to change the color and/or design of the rear housing, thus providing modification of the headphone. This ability to accessorize the headphone is advantageous because is allows the user to change the color and/or style of the headphone to coordinate with the user's other accessories or styles. In this manner, the rear housing can be selectively modified by the user by having a selectively removable decorative cap.

The decorative cap 64, 66 can include a lip around its edge that is sized and configured to interact with a corresponding ridge or lip on the rear housing base 58. The decorative cap can also be removably secured to the rear housing base by a removable adhesive, a magnetic interaction (i.e., a magnet being secured to the decorative cap and magnet being secured to the rear housing base, or alternatively with a magnetic feature on the rear housing base and a magnetic feature on the decorative base such as the decorative base being at least partially being made of a magnetic material). Furthermore, the decorative cap 64, 66 can be substantially permanently fixed to the rear housing 14 by an adhesive or interference fit.

The rear housing 14 also includes a stem 68. Stem 68 provides a mounting location for the strain relief 18. In the illustrated embodiment, the stem 68 forms an elongated member that appears to transition into the strain relief 18. However, stem 68 can simply be a portion, such as a flat lower portion of the rear housing 14, from which the strain relief 18 is coupled. In the illustrated embodiment, the stem 68 includes a strain relief mounting surface 70 on which the strain relief 18 is mounted.

Strain relief 18, in one embodiment, comprises a resilient material, such as rubber, that can bend to accommodate for movement of the cable 20. Strain relief 18 includes an aperture 72 through which the cable 20 can be positioned. For example, in one embodiment a cable 20 is received through a first end 74 of the strain relief 18, travels through the strain relief 18 and exits a second end 76 of the strain relief 18 that is coupled to the rear housing 14. The aperture 72 of the strain relief 18 can be sized and configured to substantially surround and contact the outer surface of the portion of the cable 20 that is housed by the strain relief 18. The aperture 72 of the strain relief 18 forms a cable axis 78. Thus, in the illustrated embodiment, the cable axis 78 at the strain relief 18 is substantially in line with the stem 68 of the rear housing 14. In some cases, the cable axis 78 can be parallel with the rear housing mounting plane 52. The cable axis 78 intersects with the central axis 42 of the front housing 12. Thus, in some embodiments when the front housing 12 is coupled to the rear housing 14 the cable axis 78 is normal to the central axis 42. In other embodiments, the cable axis 78, while still intersecting the central axis 42, is angled with respect to the central axis 42. Angling of the cable axis 78 with respect to the central axis 42 can position the first end 74 of the strain relief 18 either closer to or away from the user when the headphone 10 is positioned in the ear of the user.

In the illustrated embodiment, the stem 68 is positioned substantially in the lateral middle of the rear housing 14. However, it is contemplated that the stem 68 can be shifted in a plane coplanar to the rear housing mounting plane 52. As the stem 68 is shifted in a plane coplanar to the rear housing mounting plane 52, the cable axis 78, in some circumstances, may not intersect with the central axis 42. When the cable axis 78 and the central axis 42 intersect they define a stem plane 108, wherein the cable axis 78 and the central axis 42 lie in the stem plane 108. In at least one embodiment, normal to the stem plane 108 and collinear with the central axis 42 is a nozzle offset plane 110.

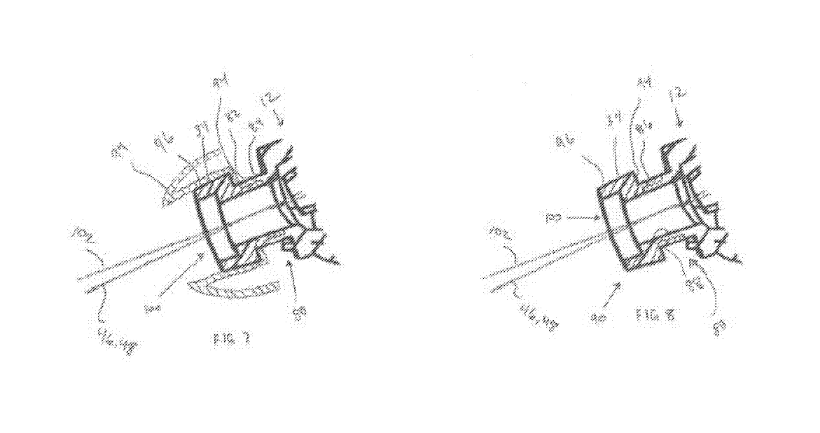

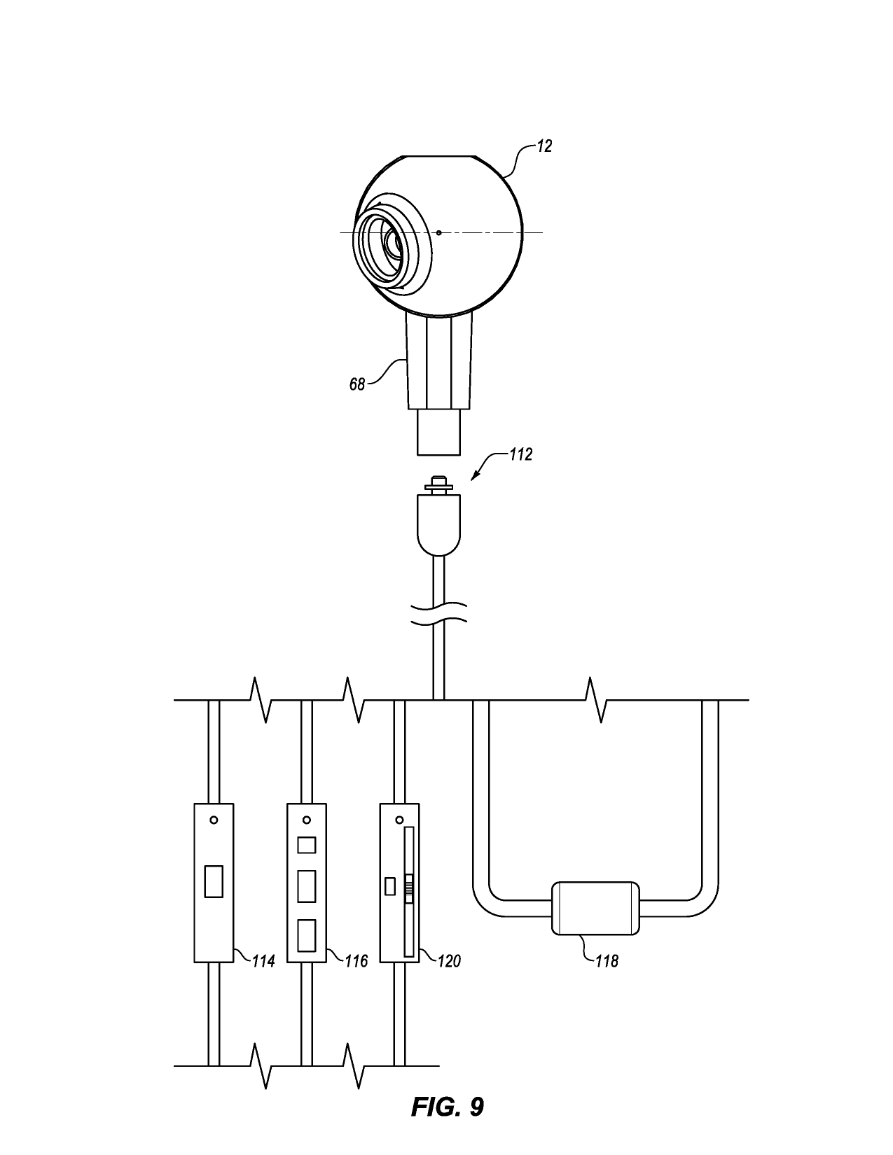

In the illustrated embodiment, the front housing 12 includes a nozzle 34. The nozzle 34 is coupled to the second side 32 of the front housing 12 and extends in a direction away from the first side 30 of the front housing 12. In one embodiment, the nozzle 34 is formed integral with the front housing 12 so as to be a single piece. However, it is contemplated that nozzle 34 can be a separate part from the front housing 12, thus either being permanently fixed to the front housing 12 or selectively removable to the front housing 12. For example, as shown in FIGS. 7 and 8, the nozzle 34 could be selectively removable to the front housing 12 by a threaded type arrangement.

In one embodiment, a first end 80 of the nozzle 34 includes a male threaded portion 82 and the second side 32 of the front housing 12 can include a corresponding female threaded arrangement 84, thus allowing for the nozzle 34 to be threaded into the front housing 12, as shown in FIG. 7. In an alternative embodiment, as shown in FIG. 8, the first end 80 of the nozzle 34 includes a female threaded portion 86 and the second side 32 of the front housing 12 can include a corresponding male threaded arrangement 88, thus allowing for the nozzle 34 to be threaded onto the front housing 12. It may be advantageous to have a selectively replaceable nozzle to accommodate for different listening styles. For example, the size and shape of the nozzle 34 can influence the frequency response heard by the user as a result of the speaker 16 being actuated.

A second end 90 of the nozzle 34 can include an ear cushion mounting surface 92 to enable a pliant ear cushion 94 to be removably mounted on the nozzle 34. The ear cushion mounting surface 92 can include a lip 98 for facilitating selectively removable securement of the ear cushion 94 to the front housing 12. The ear cushion mounting surface 92 can also include a noncylindrical or tapered portion 96. For example, the tapered portion 96 can be tapered such that the width or height of the nozzle 34 at the first end 80 is less than the corresponding width or height of the nozzle 34 at the second end 90 adjacent to the lip 98. In this manner, the tapered portion 96 enables the ear cushion 94 to more easily slide onto the nozzle 34 for attachment.

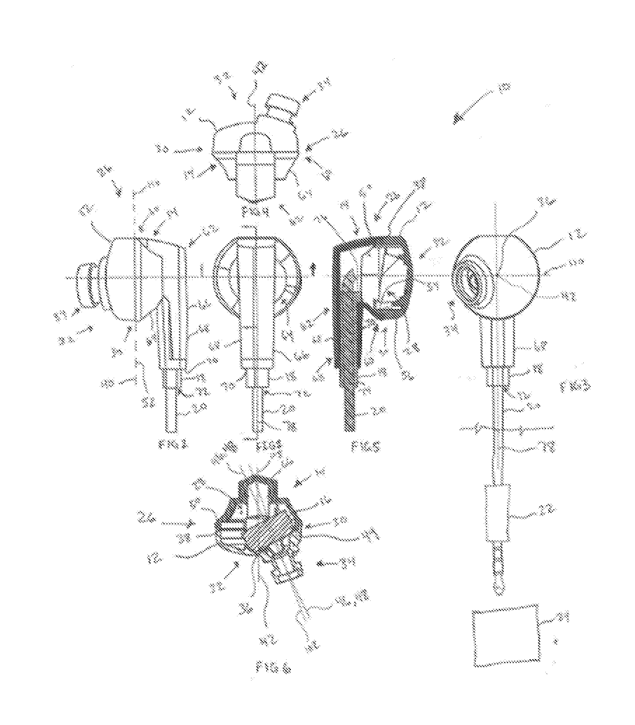

The nozzle 34 includes an opening 100 through which an audio signal (i.e., sound) from the speaker 16 can travel. The opening 100 of the nozzle 34 extends from the first end 80 of the nozzle to the second end 90 of the nozzle 34. In the illustrated embodiment, the profile of the nozzle 34 opening is oval, as shown in FIG. 3. However, it is contemplated that a variety of shapes of nozzle opening profiles can be utilized without departing from the spirit and scope of the invention.

The nozzle 34 can include a nozzle axis 102 defined by the nozzle opening 100. In the illustrated embodiment, the nozzle axis 102 is offset from the central axis 42. Furthermore, the nozzle axis 102 is orthogonal to the stem plane, nozzle offset plane and central axis 42. In this manner, the nozzle 34 is directed in a position that provides increased comfort for the user and is sized and configured to provide additional comfort for the user over longer periods of use. Furthermore, the orientation of the nozzle 34 in this manner also assists with directing sound from the speaker 16 in a manner that may improve sound quality of the headphone 10.

In the illustrated embodiment, when the front housing 12 is coupled to the rear housing 14, the cylindrical portion axis 46 of the rear housing 14 is orthogonal to the central axis 42 of the front housing 12. In other words, the center axis 48 of the speaker 16 is offset from and orthogonal to the central axis 42 of the front housing 12. The normal angle between the speaker axis 48 (i.e., center axis of speaker and/or the cylindrical housing axis) and the front housing mounting plane 40 defines the speaker axis angle. The normal angle between the nozzle axis 102 and the front housing mounting plane 40 defines the nozzle axis angle.

In the illustrated embodiment, the nozzle axis angle 106 is greater than the speaker axis angle 104. Angling of the speaker 16 in this matter allows for adaptability and interchangeability of the front housing 12 with other rear housing orientations (i.e., having the same shaped front housing with different shaped rear housings thereby forming different looking headphones). Angling of the speaker axis 48 with respect to the nozzle axis 106 influences the frequency response of the speaker 16. Orientation of the speaker 16 positioned in the front housing 12, the orientation of the nozzle 34 with respect to the front housing 12 and the orientation of the speaker axis 48 with respect to the nozzle axis 102 all influence the frequency response of the headphone 10, and the sound quality of the headphone 10 is greatly enhanced by these features.

It is understood that the headphone 10 illustrated in the Figures may be configured to fit in the right ear of a user and a configuration that is the mirror image of that disclosed could be utilized to fit in the left ear of the user.

In an alternative embodiment, the headphone 10 can include a removable cable assembly 112 thereby allowing a user to replace the cable 20 with various options of cable configuration. For example, in one embodiment, cable 20 may include a three wire cable containing a wire for the left channel, a right channel and a common ground. In another embodiment, the cable 20 may include a single button microphone 114. In another embodiment, the cable 20 may include a three button microphone 116. In another embodiment, the cable 20 may include a slider mechanism 120 for controlling volume. In another embodiment, the cable may include a Bluetooth module 118 for remote connection of the headphone 10 to an audio playback device 24.

What is claimed is:

1. An earphone comprising:
a first housing including a first housing mounting plane and a central axis normal to the first housing mounting plane;
a second housing mounted to the first housing;
a speaker mounted on the first housing, wherein the speaker defines a speaker axis; and
a nozzle having a nozzle axis and extending from the first housing,
wherein the normal angle between the speaker axis and the first housing mounting plane defines a speaker axis angle and the normal angle between the nozzle axis and the first housing mounting plane defines a nozzle axis angle, wherein the speaker axis angle is greater than the nozzle axis angle.

2. An earphone as recited in claim 1, further comprising a cable electrically coupled to the speaker, wherein the cable further includes a plug that can be coupled to an audio playback device.

3. An earphone as recited in claim 1, further comprising a detachable cable electrically coupled to the speaker.

4. An earphone as recited in claim 3, wherein the detachable cable comprises a Bluetooth module for wirelessly connecting the earphone to an audio playback device.

5. An earphone as recited in claim 1, wherein the nozzle is selectively removable from the first housing via a thread-type arrangement.

6. An earphone as recited in claim 1, wherein the nozzle is offset from the central axis.

7. An earphone as recited in claim 1, wherein the nozzle is orthogonal to the central axis.

8. An earphone comprising:
a first housing including a first housing mounting plane and a central axis normal to the first housing mounting plane;
a second housing mounted to the first housing, wherein the first and second housings define a speaker housing;
a speaker mounted in the speaker housing, wherein the speaker defines a speaker axis; and
a nozzle having a nozzle axis and extending from the first housing,
wherein the normal angle between the speaker axis and the first housing mounting plane defines a speaker axis angle and the normal angle between the nozzle axis and the first housing mounting plane defines a nozzle axis angle, wherein the speaker axis angle is different than the nozzle axis angle and wherein both the nozzle axis and speaker axis are orthogonal to the central axis.

9. An earphone as recited in claim 8, wherein the speaker is mounted on the first housing.

10. An earphone as recited in claim 8, further comprising a selectively detachable cable electrically coupled to the speaker, wherein the detachable cable comprises a Bluetooth module for wirelessly connecting the earphone to an audio playback device.

11. An earphone as recited in claim 8, wherein the nozzle is selectively removable from the first housing via a thread-type arrangement.

12. An earphone as recited in claim 8, wherein the nozzle is offset from the central axis.

13. An earphone as recited in claim 8, wherein the nozzle is orthogonal to the central axis.

14. An in-ear earphone comprising:
a first housing including a first housing mounting plane and a central axis normal to the first housing mounting plane;
a second housing mounted to the first housing thereby defining an earphone housing, the second housing having a stem extending therefrom, the stem defining a stem axis;
a speaker mounted in the earphone housing, wherein the speaker defines a speaker axis; and
a nozzle defining a nozzle axis and extending from the earphone housing,
wherein the angle between the central axis and the nozzle axis in a first plane is a first angle and the angle between the central axis and the speaker axis in the first plane is a second angle, wherein second angle is greater than the first angle, wherein the first plane is collinear with the central axis and normal to the stem axis.

15. An earphone as recited in claim 14, wherein the speaker is mounted on the second housing.

16. An earphone as recited in claim 15, wherein the second housing includes the nozzle.

17. An earphone as recited in claim 16, wherein the nozzle is selectively removable from the second housing.

18. An earphone as recited in claim 14, further comprising a cable extending through the stem and electrically coupled to the speaker.

19. An earphone as recited in claim 18, wherein the cable comprises a selectively removable cable.

20. An earphone as recited in claim 14, further comprising a cable electrically coupled to the speaker wherein the cable comprises a Bluetooth module for wirelessly connecting the earphone to an audio playback device.

21. An in-ear earphone comprising:
a first housing including a first housing mounting plane and a central axis normal to the first housing mounting plane;
a second housing mounted to the first housing thereby defining an earphone housing, the second housing having a stem extending therefrom, the stem defining a stem axis;
a speaker mounted in the earphone housing, wherein the speaker defines a speaker axis; and
a nozzle defining a nozzle axis and extending from the first housing,
wherein the angle between the central axis and the nozzle axis in a first plane is a first angle and the angle between the central axis and the speaker axis in the first plane is a second angle, wherein the first plane is collinear with the central axis and normal to the stem axis, wherein the difference between the first and second angle is less than the first angle.

22. An earphone as recited in claim 21, wherein the speaker is mounted on the second housing.

23. An earphone as recited in claim 22, wherein the second housing includes the nozzle.

24. An earphone as recited in claim 23, wherein the nozzle is selectively removable from the second housing.

25. An earphone as recited in claim 21, further comprising a cable extending through the stem and electrically coupled to the speaker.

26. An earphone as recited in claim 25, wherein the cable comprises a selectively removable cable.

27. An earphone as recited in claim 21, further comprising a cable electrically coupled to the speaker wherein the cable comprises a Bluetooth module for wirelessly connecting the earphone to an audio playback device.

28. An in-ear earphone comprising:
a first housing including a first housing mounting plane and a central axis normal to the first housing mounting plane;
a second housing mounted to the first housing thereby defining an earphone housing, the second housing having a stem extending therefrom, the stem defining a stem axis;
a speaker mounted in the earphone housing, wherein the speaker defines a speaker axis; and
a nozzle defining a nozzle axis and extending from the first housing,
wherein the angle between the central axis and the nozzle axis in a first plane is a first angle and the angle between the central axis and the speaker axis in the first plane is a second angle, wherein the first plane is collinear with the central axis and normal to the stem axis, wherein the difference between the first and second angle is less than the second angle.

29. An earphone as recited in claim 28, wherein the speaker is mounted on the second housing.

30. An earphone as recited in claim 28, wherein the nozzle is selectively removable from the second housing.

31. An earphone as recited in claim 28, further comprising a cable electrically coupled to the speaker wherein the cable comprises a Bluetooth module for wirelessly connecting the earphone to an audio playback device.
